(19) United States
(12) Patent Application Publication
(10) Pub. No.: US 2013/0277465 A1
(43) Pub. Date: Oct. 24, 2013

(54) METHOD OF ACTIVE IMPACT CRUSHING OF MINERALS AND AN ACTIVE IMPACT CRUSHER

(71) Applicants: Andrey Evarestovich KOMAROVSKY, St. Petersburg (RU); Evarest Boleslavovich Komarovsky, St. Petersburg (RU)

(72) Inventors: Andrey Evarestovich KOMAROVSKY, St. Petersburg (RU); Evarest Boleslavovich Komarovsky, St. Petersburg (RU)

(73) Assignee: Roof Corp., Belize City (BZ)

(21) Appl. No.: 13/452,924

(22) Filed: Apr. 22, 2012

(51) Int. Cl. B02C 13/20; B02C 13/26; B02C 23/08

(52) U.S. Cl. 241/5; 241/154

(57) ABSTRACT

A method of impact crushing of material includes the following steps: the material is fed to an actuator destructing the material and forwarding pieces of the material towards reflecting elements. Small material pieces are impacted by the first reflecting element and large material pieces are impacted by the second reflecting element. Impact surfaces of the reflecting elements are substantially normal to the movement directions of the pieces during the impacts. A time interval between the impacts made by the reflecting elements is defined with use of the expression Δt=(0.7 . . . 1.3)(R₁/V₁−R₂/V₂), where R₁ and R₂ are distances from a place of forwarding the pieces by the actuator to the places, where the first and second reflecting elements impact the pieces, correspondingly, V₁ and V₂ are average velocities of the pieces forwarded towards the first and second reflecting elements, correspondingly.

An impact crusher is disclosed as well.

### TECHNICAL FIELD

The invention relates to methods of crushing solid mineral and is recommended to be applied in the mineral resource industry and the mineral processing industry, the building material industry, the mining and coal industries, highway engineering, metallurgy and other fields, where processing of solid mineral and industrial raw material is carried out.

### BACKGROUND OF THE INVENTION

The applied method is a result of development and enhancement of the method of impact crushing of the U.S. Pat. No. 5,328,103 and has been called by us as a method of active impact crushing. FIG. 1 shows a scheme of motion of mineral pieces a) while coming along a feed track and into a zone of actuator rotation and b) during the scattering of the pieces after an initial impact.

The U.S. Pat. No. 5,328,103 discloses the method, when the mineral pieces of different sizes come along the feed track into the zone of the actuator rotation. It was assumed that the size of a piece coming into contact with the actuator does not matter and velocity vectors of the pieces thrown off towards rotatable reflecting elements depend only on the amount of their travel along the impact surface of the actuator.

The described method is implemented by impact crushers of different power and output, which are disclosed in the U.S. Pat. No. 5,328,103 as well, and is used in real industrial operating conditions in the processing of ore and non-metallic mineral. In such an impact crusher reflecting elements (rotors of the secondary crushing) are rotatable synchronously with the actuator (rotor of the initial crushing) and have concavo-concave impact active reflecting surfaces, wherein their masses increase from the centers of the rotor rotation along the general symmetry axes, and the radiuses of the active reflecting surfaces are made equal to the distance from the point of crossing of the feeding track plane and the circumference of the initial crushing rotor to the common active reflecting surface of the secondary crushing rotors. In this crusher the initial crushing rotor operates as a forwarding rotor, which forms the portions of the material to be crushed, partially disintegrates the pieces of the material to be crushed and forwards them towards the secondary crushing rotors (reflecting elements), which destruct the arriving material to particles of a certain size depending on the set modes by use of the method using the active impact and therefore we called them as the rotors of active impact. One more reason for this is that in this case a principle of counter and high-speed dynamic interaction of impact elements and material to be crushed is carried out.

The crushers using the active impact have revealed their high efficiency of crushing and grinding of mineral and allowed to avoid multistage and multiprocess ore pretreatment. Despite the advantages, the method has shortcomings. During the exploitation of the crushers it was revealed that the crushing efficiency is restrained, processing duration is increased and there occurs the regrinding of the crushed product, which leads to unnecessary energy consumption.

It is known in the ore mining that the ore regrinding leads to significant losses of useful components during the enrichment process. The production of the regrinded material with the size of particles less than 2 to 4 millimeters is extremely undesirable in the constructional material industry, especially in the highway engineering, because commonly such material is not used in the economy and this leads to economic and ecological side effects. The described kind of crushing is typical, for example, for jet mills, devices using the method of “the step crushing”.

### SUMMARY OF THE INVENTION

The present invention includes a method of an impact crushing of material with use of a crusher comprising a feed track, an actuator with one or more impact surfaces and two reflecting elements with impact surfaces. The actuator and the reflecting elements are rotatable synchronously. The method includes the following steps: the material is fed with use of the feed track to the actuator; the material is destructed by the actuator to pieces of different sizes and is forwarded towards the reflecting elements; and the material pieces forwarded towards the reflecting elements are contrary impacted by the impact surfaces of the reflecting elements. The material pieces forwarded towards the first reflecting element are impacted by the impact surface of the first reflecting element and the material pieces forwarded towards the second reflecting element are impacted by the impact surface of the second reflecting element. An angle between the impact surface of the each reflecting element interacting with the material pieces forwarded towards it and movement directions of these material pieces has a value from approximately 76 to approximately 104 degrees at the moment of the impact. The material pieces are impacted by the reflecting elements with a time interval between impacts of the first and second reflecting elements defined with use of the expression

Δt=(0.7 . . . 1.3)(R1/V1−R2/V2),

where:

R1 is a distance from a place, where the most distant from the actuator rotation axis point of the impact surface of the actuator is at the minimum distance from the end of the feed track, to the place, where the first reflecting element impacts the material pieces;

R2 is a distance from the place, where the most distant from the actuator rotation axis point of the impact surface of the actuator is at the minimum distance from the end of the feed track, to the place, where the second reflecting element impacts the material pieces;

V1 is an average velocity of the material pieces forwarded towards the first reflecting element; and

V2 is an average velocity of the material pieces forwarded towards the second reflecting element.

The present invention includes an impact crusher comprising a body containing a feed track, an actuator with one or more impact surfaces and two reflecting elements with impact surfaces. The actuator and the reflecting elements are rotatable synchronously. The actuator is able to impact material fed by the feed track and forward material pieces towards the reflecting elements. The reflecting elements are able to contrary impact the material pieces forwarded towards them by impact surfaces of the reflecting elements. The actuator and reflecting elements are rotatable in such a way that an angle between the impact surface of the each reflecting element interacting with the material pieces forwarded towards it and movement directions of these material pieces has a value from approximately 76 to approximately 104 degrees at the moment of the impact. The reflecting elements are rotatable in such a way that a value of a time interval between the impacts made by the impact surfaces of the first and second reflecting elements on the material pieces forwarded towards them is defined with use of the expression

Δt=(0.7 . . . 1.3)(R1/V1−R2/V2);

where R1 is a distance from a place, where the most distant from the actuator rotation axis point of the impact surface of the actuator is at the minimum distance from the end of the feed track, to the place, where the first reflecting element impacts the material pieces;

R2 is a distance from the place, where the most distant from the actuator rotation axis point of the impact surface of the actuator is at the minimum distance from the end of the feed track, to the place, where the second reflecting element impacts the material pieces;

V1 is an average velocity of the material pieces forwarded towards the first reflecting element; and

V2 is an average velocity of the material pieces forwarded towards the second reflecting element.

### BRIEF DESCRIPTION OF THE DRAWINGS

FIG. 1 shows a method of active impact crushing.

FIG. 2 shows a general diagram of kinetics of material to be crushed.

FIG. 3 shows the first stage of kinetics of material to be crushed.

FIG. 4 shows the second stage of kinetics of the material to be crushed.

FIG. 5 shows the third stage of kinetics of the material to be crushed.

FIG. 6 shows the fourth stage of kinetics of the material to be crushed.

FIG. 7 shows a diagram of the gravel (macadam) producing by crushing.

FIG. 8 shows a diagram of the suction device positions.

FIG. 9 shows an active impact crusher.

FIG. 10 shows an active impact crusher.

### DETAILED DESCRIPTION

The base of the present invention is the object to develop the method of the impact crushing, which allows to increase crushing efficiency, the crushed product quality and at the same time decrease the power consumption of the process. The object is to avoid regrinding of the material and to reduce duration of the crushing as well. The additional object of the present invention is to ensure that flows of the material to be crushed are not obstacles for each other in the crusher during the crushing process.

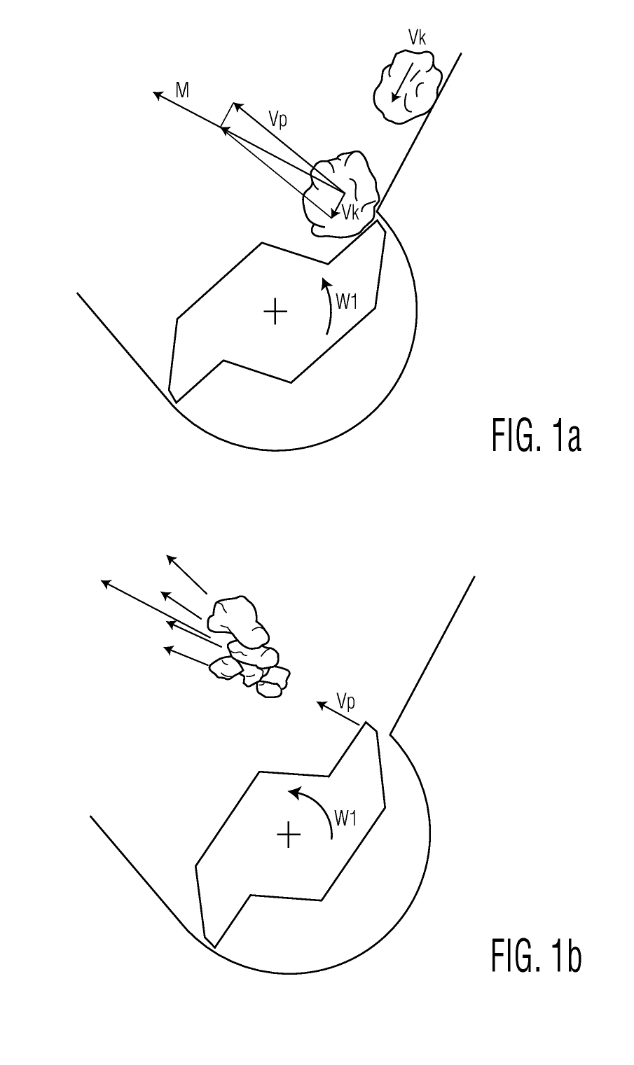

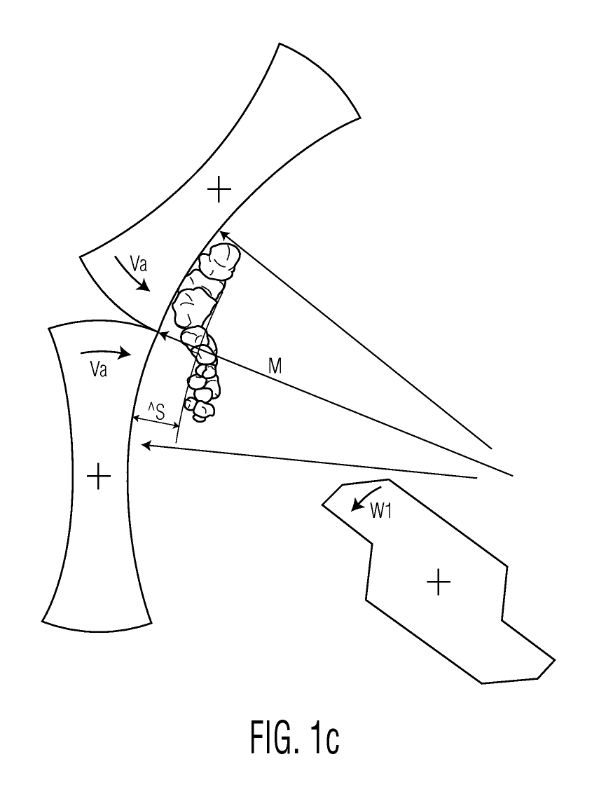

During the exploitation of the crushers it was revealed that (as FIG. 1c) shows) small pieces come to a reflecting element with a lag relative to time of coming of large pieces to the reflecting element, the lag depending on the size and the velocity of the pieces. In this case crushing occurs sequentially—the material being crushed is broken at first through interaction with the upper (second) reflecting element and later—in a certain time interval—through interaction with the lower (first) reflecting element.

The reason of the insufficient efficiency of the crusher is that neither the velocities nor the sizes of the pieces of the material to be crushed and forwarded by the actuator to the reflecting elements are taken into account. Without taking into account these factors it is impossible to achieve the enhanced crushing efficiency in full measure, this can especially be observed in processing of strong and very strong mineral. Two reflecting elements forming the common reflecting surface at the moment of the impact with the material to be crushed (the moment of the secondary impact) cannot come into contact with the large and small pieces of the material simultaneously or in such a way, that the impact surfaces of the reflecting elements are normal (perpendicular) to the flight directions of the large and small piece. It is due to the fact that at first the large pieces fly up to this surface and only then the small pieces, wherein the large and small pieces fly up with different velocities. It is shown in the paper “Rotary crushers” edited by Bauman V. A., Moscow, Mashinostroenie, 1973, pp. 44-45. In accordance with this paper the velocity of the less destructed (i.e. larger) pieces can excess the average velocity of the pieces up to 2 times. Thus, if the large pieces came to the reflecting element earlier than the small pieces were crushed by the impact surface of the reflecting element normal to the direction of the pieces flight, the small pieces cannot be efficiently crushed since the reflecting element had time to turn and its impact surface is no longer normal to the flight direction of the small pieces. And vice versa, if the small pieces come to the reflecting element at the time when its impact surface is normal to the flight direction of these pieces and therefore they are efficiently crushed, the large pieces came earlier would not be crushed since the impact surface of the reflecting element was not normal to the flight direction of the pieces during the striking them due to the fact that the reflecting element had not enough time to come into the perpendicular or close to perpendicular position.

Therefore, to solve the object of the present invention, the reflecting elements should crush the forwarded towards them pieces of the material to be crushed in such a way that the impact surfaces of the both reflecting elements are normal to the flight directions of the pieces of the material to be crushed during interaction of the impact surfaces and the pieces of the material. Such a result can be achieved as well, if the reflecting elements interact with the large and small pieces of material to be crushed simultaneously.

It was determined that the crushing efficiency is restrained and processing duration is increased due to the fact that the material concentrating in one place overloads the actuator and the grate as well. It was determined that the material regrinding occurs and a withdrawal of the grinded product from the process is decelerated throughout a purposive mutual collision of the flows of the particles of the mineral being crushed. The material crushed by the upper reflecting element is thrown off into the zone of actuator rotation and is partly mixed with the newly arrived material, but the main part of the material goes to a grate under the actuator. Then the material crushed by the lower reflecting element is thrown off into the same zone.

It means that the efficiency is reduced and the power inputs for the crushing increase, because input power is also spent for a plastic deformation, which does not result in the destruction but consumes the most part of the input power. The reason of the excessive grinding, the restrained crushing productivity and the increased consumption of the supplied electric power is absence of devices for distribution and control of flows of the crushed to the necessary size participles of the material in the crusher in order to avoid crossing of these flows with each other in time.

The main object of the present invention is solved by a method of impact crushing of material with use of a crusher comprising a feed track, an actuator with one or more impact surfaces and two reflecting elements with impact surfaces, wherein the actuator and the reflecting elements are rotatable synchronously, the method includes the following steps;

the material is fed with use of the feed track to the actuator;

the material is destructed by the actuator to pieces of different sizes and is forwarded towards the reflecting elements;

the material pieces forwarded towards the reflecting elements are contrary impacted by the impact surfaces of the reflecting elements, wherein the material pieces forwarded towards the first reflecting element (the small pieces) are impacted by the impact surface of the first reflecting element and the material pieces forwarded towards the second reflecting element (the large pieces) are impacted by the impact surface of the second reflecting element.

The method is characterized in the following.

In order to increase the efficiency and productivity of mineral crushing an angle between the impact surface of the each reflecting element interacting with the material pieces forwarded towards it and movement directions of these material pieces has a value from 76 to 104 degrees at the moment of the impact,

wherein the material pieces are impacted by the reflecting elements with a time interval between impacts of the first and second reflecting elements defined with use of the expression

Δt=(0.7 . . . 1.3)(R₁/V₁−R₂/V₂),

where R₁ is a distance from a place, where the most distant from the actuator rotation axis point of the impact surface of the actuator is at the minimum distance from the end of the feed track, to the place, where the first reflecting element impacts the material pieces,

R₂ is a distance from the place, where the most distant from the actuator rotation axis point of the impact surface of the actuator is at the minimum distance from the end of the feed track, to the place, where the second reflecting element impacts the material pieces,

V₁ is an average velocity of the material pieces forwarded towards the first reflecting element, and

V₂ is an average velocity of the material pieces forwarded towards the second reflecting element.

The part of the said expression (0.7 . . . 1.3) indicates a factor having a value from 0.7 to 1.3. Any value of the factor in this range ensures efficiency of the disclosed method. In a preferable embodiment of the invention in order to maximize efficiency of the method the said time interval is defined with use of the expression Δt=R₁/V₁−R₂/V₂. i.e. the said factor has unit value.

In order to increase the efficiency and productivity of mineral crushing the forwarded by the actuator flow of the material to be crushed is divided into two flows at the moment of an interaction with the reflecting elements.

At the moment of impacts, each impact surface of the reflecting element interacting with the material pieces is preferably at the angle from 76 degrees to 104 degrees (i.e. substantially normal, 90 degrees plus-minus 14 degrees) to the movement direction of the material pieces. The said position of the impact surfaces can be provided by concentric shapes of the impacting surfaces of the reflecting elements and concentric arrangement of the impacting surfaces of the reflecting elements during the impacting the material pieces relative to the most distant from the actuator rotation axis point of the impact surface of the actuator is at the minimum distance from the end of the feed track.

To produce homogeneous material of larger fraction, for example, macadam (gravel), in one embodiment the mode of crushing providing the relations

V₁=(0.1 . . . 0.35)(Vₚ+Vₐ₁),

V₂=(0.1 . . . 0.35)(Vₚ+Vₐ₂),

where Vₚ is the linear velocity of the most distant from the actuator rotation axis point of the impact surface of the actuator is at the minimum distance from the end of the feed track, Vₐ₁ and Vₐ₂ are the linear velocities of the most distant from corresponding reflecting element rotation axes points of the impact surfaces of the first and second reflecting elements, is set by adjustment of the velocities of the actuator and the reflecting elements, and the material interacted with the reflecting elements is forwarded to limiters set tangentially relative to the direction of the material pieces motion. The limiters could be moveable, in this case they should be openable, i.e. be relocatable to the tangential position relatively to the direction of the material motion in order to function as passive reflecting elements. The reflecting elements advantageously have identical lineal dimensions, angular velocities of rotation and identical linear velocities.

In order to increase the crushing efficiency and reduce the material regrinding the material crushed throughout the interaction with the reflecting elements and consisting of the particles less than 0.2 millimeters can be removed from the process preferably by means of suction devices disposed in the crushing chamber, for example, under the limiters.

To ensure that flows of the material to be crushed are not obstacles for each other in the crusher during the crushing process, the material pieces interacted with the second reflecting element can be forwarded to a zone under the first reflecting element by additional reflecting element.

In order to increase the efficiency of mineral crushing during concentrating the material forwarded by the additional reflecting element to a zone under the first reflecting element (for example, to a limiter disposed under the first reflecting element) can be forwarded to the impact surface of the second reflecting element, wherein the effective cross-sections of the limiters are preferably closed.

The object of the present invention is also solved by an impact crusher for implementing the aforesaid methods comprising a body containing a feed track, an actuator with one or more impact surfaces and two reflecting elements with impact surfaces, wherein the actuator and the reflecting elements are rotatable synchronously. Rotation synchronism could be obtained by a kinematical connection. The actuator is able to impact material fed by the feed track and forward material pieces towards the reflecting elements. The reflecting elements are able to contrary impact the material pieces forwarded towards them by their impact surfaces.

The crusher is characterized in that in order to increase the efficiency of crushing and quality of the product the actuator and reflecting elements are rotatable in such a way that an angle between the impact surface of the each reflecting element interacting with the material pieces forwarded towards it and movement directions of these material pieces has a value from 76 to 104 degrees at the moment of the impact.

The reflecting elements are rotatable in such a way that a value of a time interval between the impacts made by the impact surfaces of the first and second reflecting elements on the material pieces forwarded towards them is defined with use of the expression

Δt=(0.7 . . . 1.3)(R₁/V₁−R₂/V₂),

where R₁ is a distance from a place, where the most distant from the actuator rotation axis point of the impact surface of the actuator is at the minimum distance from the end of the feed track, to the place, where the first reflecting element impacts the material pieces,

R₂ is a distance from the place, where the most distant from the actuator rotation axis point of the impact surface of the actuator is at the minimum distance from the end of the feed track, to the place, where the second reflecting element impacts the material pieces,

V₁ is an average velocity of the material pieces forwarded towards the first reflecting element, and

V₂ is an average velocity of the material pieces forwarded towards the second reflecting element.

0.7 . . . 1.3 is a factor taking into account dynamics of the collision process for a given fineness of the initial material and defined characteristics of a grain-size composition of the crushing product.

In a preferable embodiment of the crusher the value of the said time interval is defined with use of the expression Δt=R₁/V₁−R₂/V₂.

The reflecting elements are preferably rotatable in such a way that their impact surfaces are preferably at the angle from 76 degrees to 104 degrees (i.e. substantially normal) to the movement direction of the material pieces normal to corresponding movement directions of the material pieces interacting with them. The aforesaid arrangement of the impact surfaces of the reflecting elements relatively to the movement directions of the pieces can be achieved by concentric shape of the impacting surfaces and their concentrically arrangement during the impacting the material pieces relative to the most distant from the actuator rotation axis point of the impact surface of the actuator is at the minimum distance from the end of the feed track.

The crasher preferably comprises an additional reflecting element located between the actuator and the second reflecting element and reflecting the material pieces forwarded by the second reflecting element to a zone under the first reflecting element. This feature prevents the flows of the crushed material from being obstacles to each other during the process of crushing.

The additional reflecting element is advantageously located between the actuator and the second reflecting element in the vertex of the triangle having a base passing from the place, where the most distant from the actuator rotation axis point of the impact surface of the actuator is at the minimum distance from the end of the feed track, to a place, where the most distant from corresponding reflecting element axes points of the impact surfaces of the reflecting elements are at the minimum distance from each other, wherein the angle between the base of the triangle and a side of the triangle connecting the center of a reflecting surface of the additional reflecting element and the place, where the most distant from the actuator rotation axis point of the impact surface of the actuator is at the minimum distance from the end of the feed track, is about 35 degrees plus-minus 10 degrees. In the preferable embodiment the additional reflecting element is can adjust its angular position within the limits of 20 degrees to each direction relative to its middle angular position. A turning axis can be located in the center of the additional reflecting element and a hinge is advantageously placed in the upper or lower part of the element.

The crusher preferably contains limiters forming a gap between the actuator or the reflecting element and a surface of the limiter. These limiters can be moveable in grooves of the crusher body and forming the necessary gaps between the ends of the impact elements of the actuator or the reflecting element and working surfaces of the limiters. Moreover, the limiters can have clearing openings, which can be adjustable on their effective cross-sections.

In one embodiment a bumper is located between the limiters of the actuator and the first reflecting element; the bumper can be attached to the limiters. The bumper can comprise clearing openings.

In the preferable embodiment of the crusher the feed track is adjustable on the position of the feed track end with respect to the actuator (i.e. with respect to the point of loss of the contact of the material to be crushed with its surface). For this purpose the feed track can comprise a pivoted hinge at the upper part of the feed track and fixing means at the lower part of the feed track and the fixing means could be able to fix the feed track continuously or discretely up to 15 degrees to each direction from the middle position of the feed track.

The distances R₁ and R₂ preferably have the following relation: R₁≦R₂≦(V₂/V₁)R₁.

In one of the embodiments the distance R₂=(V₂/V₁)R₁ and Δt=0, i.e. the impact surfaces of the reflecting elements interact with the material pieces simultaneously.

During commercial operation of the active impact crushers there were carried out some experiments directed towards optimization of the process of mineral destruction and revealing of opportunities to increase crushing efficiency using the advantages of the active interaction. It was ascertain in that way that the elimination of the intersection and collision of the flows of the material to be crushed leads to the sufficient increase of crushing efficiency, wherein the reduction of regrinding of the material was noticed as well.

The characterizing feature of the method of active impact crushing is that directed impacts of the reflecting elements are synchronized with the impacts of the actuator and their impact surfaces are oriented perpendicularly to the velocity vectors of the pieces forwarded by the actuator, wherein the linear motion velocity of the reflecting elements is preferably 0.3 to 3.5 of the actuator linear velocity.

The proposed method of active impact crushing allows to eliminate the shortcomings of the present crushers by division of the flow of the material forwarded by the actuator into two flows. The time interval between impacts of the reflecting elements on the material pieces is set accordingly their velocity and distance from the place of the actuator impact to the place of the reflecting element impact.

The proposed method and crusher provide the increase of the crushing efficiency and the quality of the final product. In accordance with the present invention the power consumption per ton of the crushed material is practically 3 and more times less as compared with the crushing methods in operation.

The object of the present invention is to increase the productivity and efficiency of the crushing through elimination of the aforementioned shortcoming, which lies in that the impacting surfaces of the reflecting elements are not normal during the impacts with the flying directions of the pieces of the material to crushed forwarded to the respective reflecting elements. The said perpendicularity can be achieved by concentric shape of the impacting surfaces and their concentrically arrangement during the impacting the material pieces relative to the point of the impact surface of the actuator, which is the farthest from the actuator rotation axis, when it is at the minimum distance from the end of the feed track.

It was determined by the investigations that in the impact rotary crushers the deviations of the piece flight directions after the impact of the actuator, where the scattering is fan-shaped, correspond to Gaussian law. The most probable direction of the flight—the average or modal direction—is determined by geometrical sum of velocities Vₖ of the pieces coming along the feed track to crushing and the velocity Vₚ of the actuator (see FIG. 1a). It was shown that the pieces of small size are thrown off in the modal (the most probable) direction and closer to the actuator (towards the first of lower reflecting element), and the large pieces are thrown off away from the actuator (towards the second of upper reflecting element) (see FIG. 1b). It should be noted that even if the equal sized pieces come into the crusher, they can be crushed into pieces of different sizes by the impact of the actuator. The actuator can be implemented as a rotatable rotor having one or more impact surfaces.

It was determined as well that independently of the rotational speed of the actuator the scattering diagram of the material to be crushed does not change: after the primary impact the small pieces scatter in the modal direction and closer to the actuator and the large pieces have a flight vector directed away from the actuator, i.e. in accordance with the influence of the centrifugal forces directed from the center of gravity of each piece.

Such a situation is typical for both the undestructed pieces of different sizes and partly destructed pieces broken at a plane of the maximum radius of rotation of the actuator throughout the contact of pieces of the material to be crushed with the surface of the crushing element. In other words, investigations reveal that the flow of the impacted by the actuator material is divided at least two flows depending on the angle: the flow of small pieces and the flow of large pieces.

This conclusion was used to invent the method of active impact provided with the synchronization of the impacts of the actuator and reflecting elements and to design the crusher with active impact.

The fulfilled analytical investigations and experiments resulted in the determined fact that the interaction of the mineral pieces of different sizes and having different vector quantities of velocities after the impact of the actuator with the reflecting elements takes place not simultaneously on the whole working surface but with delay of the contact of the small pieces of the material to be crushed and the impact surfaces of the reflecting elements relative to the contact of the large pieces.

The value of this delay is equal to the following:

ΔT=R₁/V₁−R₂/V₂,

where R₁ is a distance from a place, where a point of the impact surface of the actuator, which is the farthest from an actuator rotation axis, is at a minimum distance from the end of the feed track (i.e. the place, where the actuator impacts the pieces of the material to be crushed coming along the feed track), to a place, where the material pieces forwarded towards the first reflecting element are impacted by the impact surface of the first reflecting element;

R₂ is a distance from the place, where the point of the impact surface of the actuator, which is the farthest from the actuator rotation axis, is at the minimum distance from the end of the feed track, to a place, where the material pieces forwarded towards the second reflecting element are impacted by the impact surface of the second reflecting element;

V₁ is an average velocity of flight of the material pieces forwarded towards the first reflecting element and

V₂ is an average velocity of flight of the material pieces forwarded towards the second reflecting element.

The aforementioned distances and average velocities of flight of the material pieces can be measured experimentally with use of appropriate measuring equipment or by means of video recording, which can be accelerated. The distances R₁ and R₂ usually are set taking into account dimensions of crushing equipment, fineness (size) of the material to be crushed, conditions of efficient operation of a crusher and relative positions of the actuator and the reflecting elements. Principles and examples of selection of these distances can be found in the state of the art. The velocities V₁ and V₂ depend on a linear velocity of the most distant from the actuator rotation axis point of the impact surface of the actuator, which could be determined on the base of an angular velocity of actuator rotation and a distance from the actuator rotation axis of the most distant point of the impact surface, and size and weight of the forwarded material pieces and the velocity of material feeding by the feed track.

The flow of the partly crushed and directed by the actuator material has a shape of a fan consisting of flows of differently sized pieces, this fan-shaped flow has at least two parts depending on fineness. One part flying closer to the actuator gets the impact from the first (lower) reflecting element having the counter linear velocity Vₐ₁ of the most distant from the rotation axis point of the impact surface. The other part flying away from the actuator gets the impact from the other (upper) reflecting element having a counter velocity Vₐ₂ of the most distant from the rotation axis point of the impact surface. The impacts of the first and second reflecting elements are carried out with time delay, its value (or modulo of value) is determined by the average velocities of flight of the small and large pieces and the distances from the place of forwarding of the said pieces by the actuator towards the reflecting elements:

Δt=(0.7 . . . 1.3)(R₁/V₁−R₂/V₂).

The factor (0.7 . . . 1.3) showing the range of possible values of the time interval between impacts made by the reflecting elements reflects characteristics of the fineness of the initial material and the grain-size composition of the crushing product and can take into account manufacturing tolerances and tooling. If the value of the time interval between impacts is within the said range, the crushing efficiency is achievable. The efficiency is optimal, when the value of the time interval between impacts is equal to the value of the delay of the small pieces relatively to large pieces.

Due to the fact that collision of the impact surfaces of the reflecting elements and the material pieces takes place with the said time interval depending on piece velocities and the length of the paths traversed between the actuator and the reflecting elements, the aforementioned perpendicularity or the close to perpendicular value of the angles between the impact surfaces of the reflecting elements and flight directions of the material pieces forwarded towards them is achieved both for the small pieces of material forwarded by the actuator towards the first reflecting element and the large pieces of material forwarded by the actuator towards the second reflecting element. In other words, such perpendicularity is achieved both for the first reflecting element and the second reflecting element.

The said time interval between impacts made by the reflecting elements on the pieces of the material to be crushed can be defined by calculation with use of values of the distances R₁ and R₂ set on the base of reason from the state of the art and measured values of the material pieces velocities V₁ and V₂. This time interval can be set by tuning of initial relative positions of rotation of the reflecting elements made in the form of rotatable rotors in such a way that the impact surfaces of the both reflecting elements can be substantially normal to directions of flight of the material pieces at moments of impacts. Time of the impacts and positions of the impact surfaces of the reflecting elements can be measured, for example, experimentally with use of appropriate equipment or accelerated video recording. Time of impact is determined for the most part (60% or more) of material pieces forwarded to the reflecting element and can be, for example, averaged for all or part of impacted pieces.

It is shown by experiments that efficient crushing is achieved during collision of the impact surfaces of the reflecting elements with the material pieces at the prescribed distances R₁ and R₂, if the said impact surfaces are at the angle from 76 to 104 degrees to the flight direction of the material pieces at the moment of the impact. The most efficiency is achieved when the impact surfaces are normal (at the angle of 90 degrees) to the flight direction of the material pieces at the moment of the impact. If the value of the angle is outside of the said range (i.e. less than 76 degrees or more than 104 degrees), the crushing efficiency drop below acceptable value and regrinding can occur. The value of the angle can be calculated or experimentally measured with use of appropriate equipment. This value can be defined with help of video recording as well. The video recording can be, for example, accelerated (made with a speed higher than a speed of viewing).

The substantially normal positions of the impact surfaces of the rotatable reflecting elements relative to flight directions of the material pieces can be set by appropriate initial relative position of rotation of the actuator and the reflecting elements in such a way that the material pieces forwarded by the actuator contact with the reflecting elements having occupied (by means of rotation) positions providing perpendicularity of their impact surfaces and directions of movement of the material pieces forwarded by the actuator. The directions of movement of the material pieces forwarded by the actuator can be approximated by lines (or a fan of lines) connecting the place or point, where the most distant from the actuator rotation axis point of the impact surface of the actuator is at the minimum distance from the end of the feed track (in other words the place where the actuator forwards the material pieces towards the reflecting elements), and the points of the impact surfaces of the reflecting elements.

The initial relative positions of rotation of the actuator and the reflecting elements can be defined by values of time intervals between forwarding the material pieces by the actuator and contrary impacts of the reflecting elements on the forwarded material pieces, i.e. between moment of taking by the actuator the position, where the most distant from the actuator rotation axis point of the impact surface of the actuator is at the minimum distance from the end of the feed track, and moments of taking by the reflecting elements the positions, where their impact surfaces are substantially normal (have angles from 76 to 104 degrees) to the line, connecting the point, where the most distant from the actuator rotation axis point of the impact surface of the actuator is at the minimum distance from the end of the feed track, and the points of these impact surfaces. These time intervals have values of R₁/V₁ and R₂/V₂ for the first and second reflecting elements correspondingly.

In one embodiment this perpendicularity or the close to perpendicular value of the angles between the impact surfaces of the reflecting elements and flight directions of the material pieces forwarded towards them is provided with simultaneous impacts between both reflecting elements and the forwarded towards them material pieces. In this case the second reflecting element should be further than the first reflecting element, i.e. R₂=(V₂/V₁)R₁.

In another embodiment the substantially perpendicular positions of the impact surfaces of the reflecting elements relatively to the flight directions of the material pieces at the moments of the impacts can be achieved for the case when R₁=R₂=R by setting the time interval between taking by the reflecting elements the perpendicular positions relative to line connecting the place, where the most distant from the actuator rotation axis point of the impact surface of the actuator is at the minimum distance from the end of the feed track, and the points of the impact surfaces of the first and second reflecting elements equal to R(1/V₁−1/V₂).

After interaction with the second (upper) reflecting element the material can be forwarded to an additional and mainly passive reflecting element, which can have concave surface and reflect the material into a zone located under the first (lower) reflecting element and preferably dimensioned as 0.5 of the rotating radius of the most distant from the rotational axis point of the impact surface of the first reflecting element, wherein the center of the zone is disposed at a line connecting a rotational axis of the actuator with the rotational axis of the first reflecting element at a distance of ¾ of the rotating radius of the most distant from the rotational axis point of the impact surface of the first reflecting element, wherein the material forwarded by the actuator and interacting with the first reflecting element is preferably forwarded into a space under the actuator.

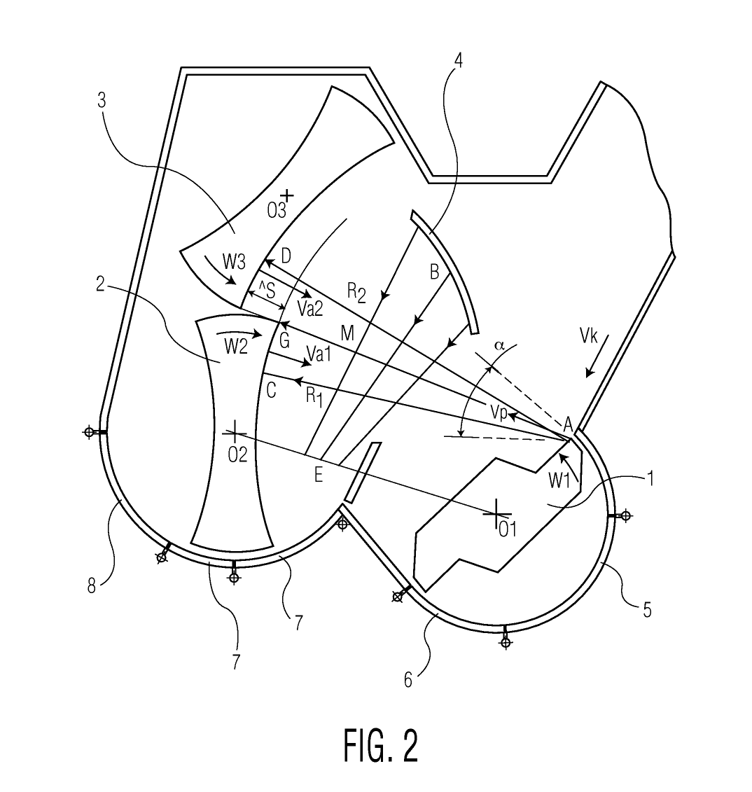

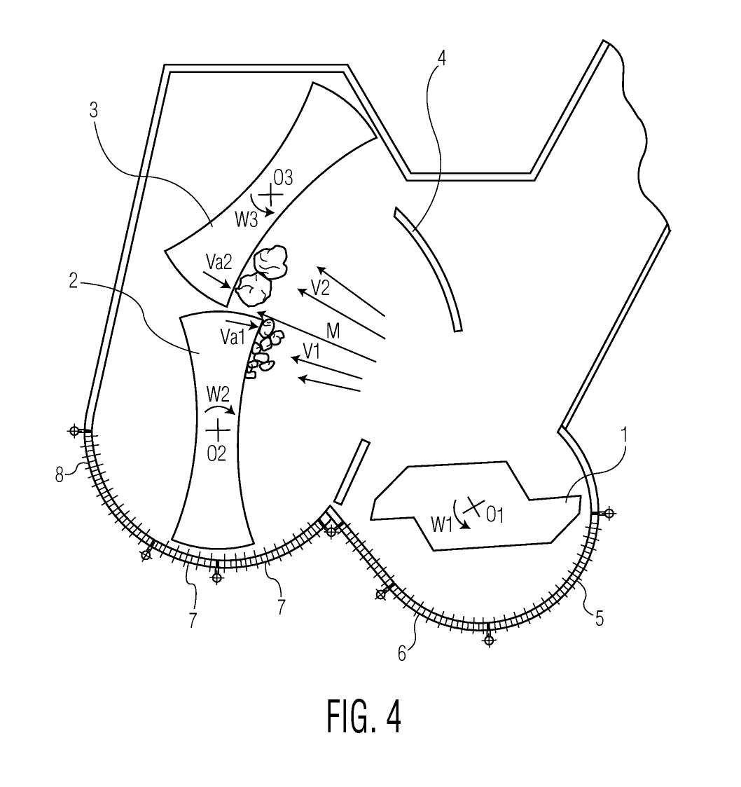

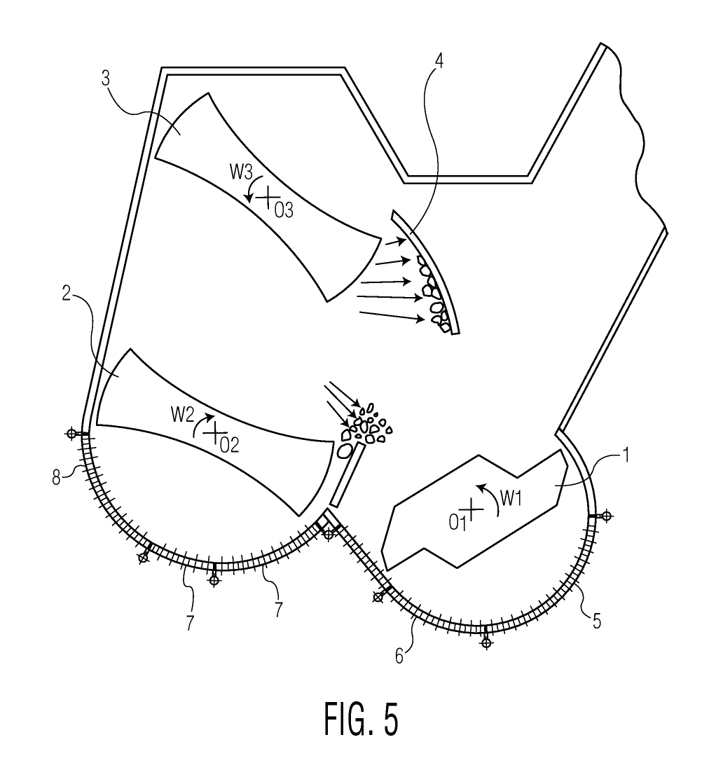

Implementation of the proposed method is illustrated by FIGS. 2 to 8.

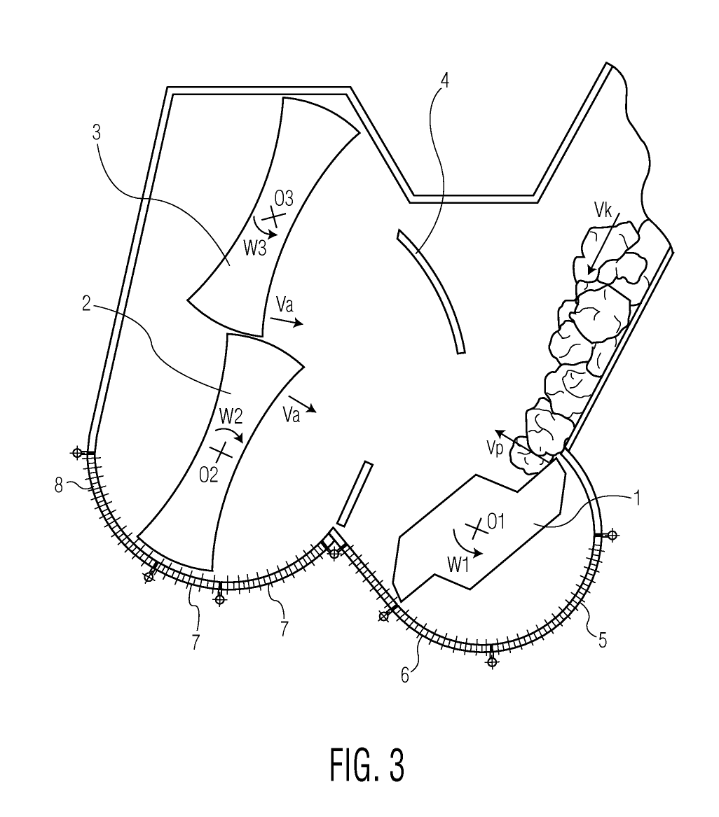

FIG. 2 shows a general diagram of the method implementation and FIGS. 3, 4, 5, 6 show separate stages of crushing and motion of the crushing product in the embodiment, when Δt=0 and R₂=R₁(V₂/V₁).

The material is forwarded with the scattering angle alpha (the probability of material getting to the sector of this angle is 92%) from a place of loss the contact of material to be crushed along a line of intersection of the fees track with the rotational circumference of the actuator 1 (the point A) towards reflecting elements having the rotational center O2 of the first (lower) reflecting element 2 and the rotational center O3 of the second (upper) reflecting element 3. The average direction of the piece flight (the middle of a fan-shaped flow—mode M) is formed on the line AG. The flight of the smaller pieces passes from the actuator along the line AC (vector R₁), and the flight of the larger pieces passes from the actuator along the line AD (vector R₂). The distance ̂S formed in accordance with the embodiment of the present invention allows to compensate lack of the velocity of the smaller pieces and difference of the piece sizes of the material to be crushed and to carry out the interaction of the material with the impact surfaces of the both reflecting elements simultaneously. Taking into account adjustable inertial force of the impact of the reflecting elements, the large and small pieces of the mineral are destroyed up to the fractions determined by the operating conditions.

Further the flow of the crushed material is forwarded from the second reflecting element 3 to the concave reflecting surface of the additional reflecting element 4 forwarding the material into the zone E, the center of the zone is on the line connecting rotational axes O1 and O2 of the actuator and the first reflecting element. The dimension of the zone E is ¼ of the maximum linear dimension of first reflecting element at a sectional plane orthogonal to the rotation axis. The segment O2E is equal to ¾ of the rotational radius of the point of the reflecting element 2, which is maximum remote from the rotational axis at the sectional plane orthogonal to the rotational axis, i.e. to ⅜ of the maximum linear dimension of first reflecting element at the sectional plane orthogonal to the rotational axis from the rotational axis of this element.

The crushed material thrown off from the reflecting element 2 is forwarded towards the actuator 1. The actuator catches the material and forwards it to the limiters 5 and 6 used for unloading the product.

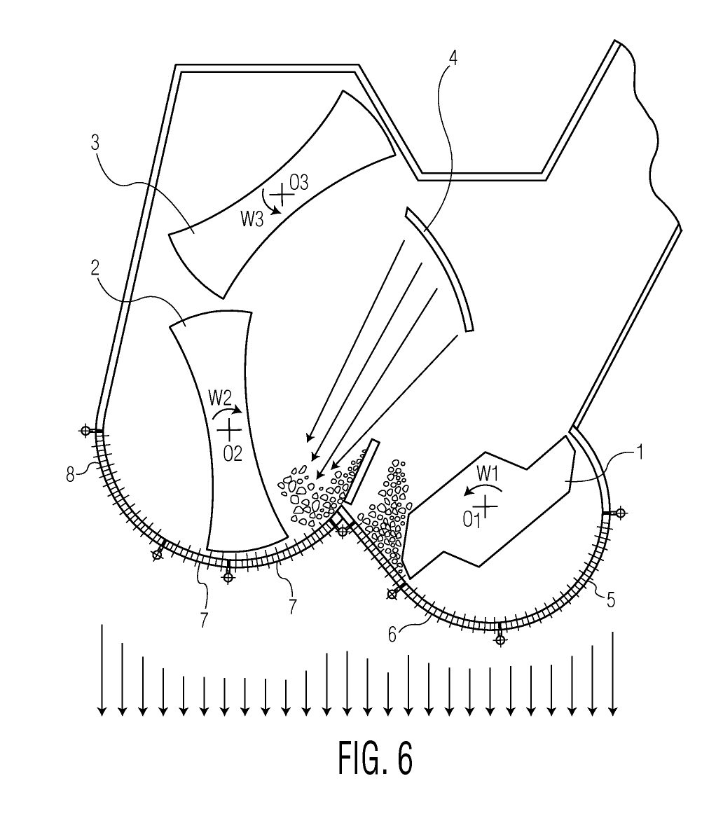

The crushed material forwarded by the additional reflecting element 4 to the zone E (see FIG. 2) is caught by the reflecting element 2 and unloaded from the process through the limiters 7 and 8. FIG. 6 shows the final stage of the process.

Another embodiment of the proposed method provides the efficient process of the crushing intended for producing the macadam (gravel) fraction of nonmetallic minerals (5 to 10, to 20, 20 to 40 millimeters, etc.). To implement this process the mode of crushing providing the relations

V₁=(0.1 . . . 0.35)(Vₚ+Vₐ₁),

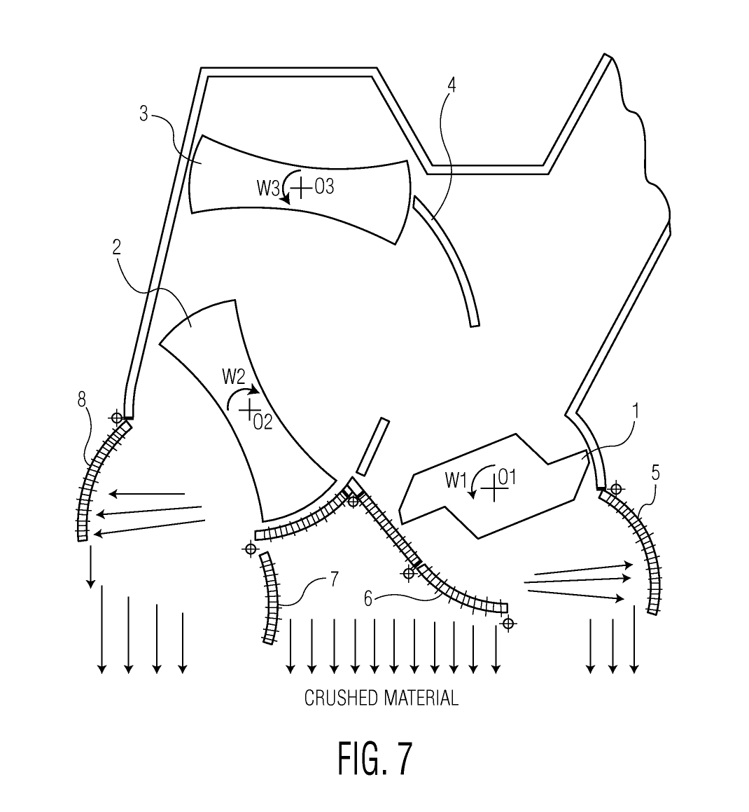

V₂=(0.1 . . . 0.35)(Vₚ+Vₐ₂),

where Vₚ is the linear velocity of the point of the impact surface of the actuator, which is the most distant from the actuator rotation axis, Vₐ₁ and Vₐ₂ are the linear velocities of points of the impact surfaces of the first and second reflecting elements, which are the most distant from reflecting element rotation axes, is set by adjustment of the velocities of the actuator and the reflecting elements, and the material interacted with the reflecting elements is forwarded to limiters 6 and 7 set tangentially relative to the direction of the material pieces motion (the withdrawing vector of the product) and the limiters 5 and 8 are set into a position for unconfined withdrawal and used as passive bumpers. FIG. 7 shows this diagram. The limiters could be moveable, in this case they should be openable, i.e. be relocatable to the tangential position relatively to the direction of the material motion in order to function as passive reflecting elements.

In order to provide overall grinding of the material to be crushed, which is necessary for concentrating during flotation, and to complete crushing of hard and very hard minerals, the limiters 5, 6, 7, and 8 close the passage for the crushed material and the material is forwarded to the impact surface of the reflecting element 3 by the reflecting element 2.

When crushing metallic mineral, the material is basically not strong and easy destructible, there arise a necessity of fast withdrawal of fine grinded product from the process in order to avoid possible regrinding, because if regrinding occurs, a part of the product is lost throughout the concentrating and the technology of concentrating of the fine grinded product becomes difficult to implement.

In order to solve this problem, when the method of active impact crushing resulting in the producing the fine product is carried out, the suction devices tuned to withdrawal of the grinded product less than 0.2 millimeters are proposed to place in the crushing camera under the limiters outside the zone of impacts.

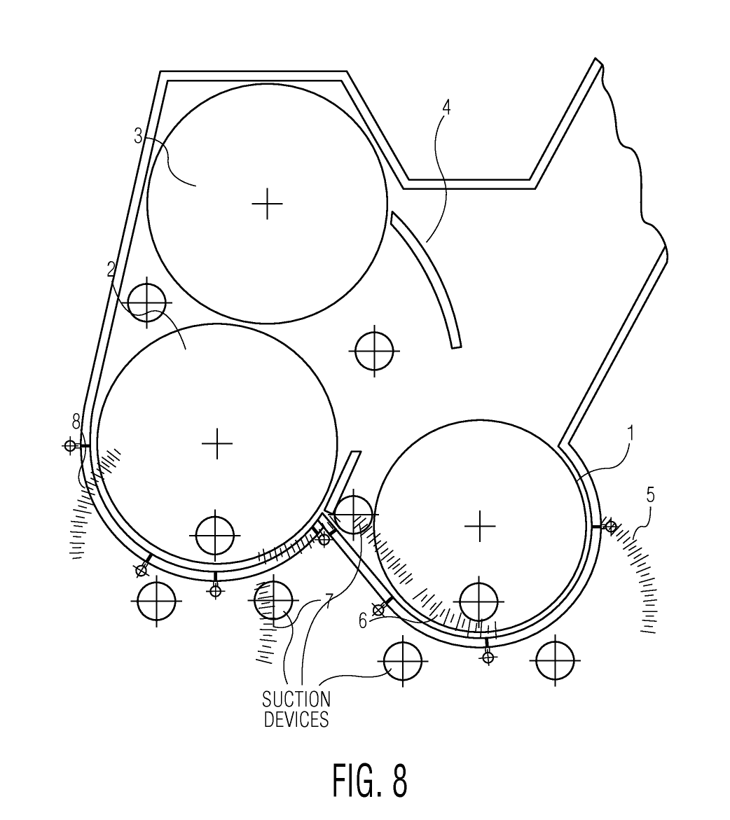

FIG. 8 shows the diagram of the suction device placement.

It should be mentioned that the flows of the material to be crushed forwarded towards the reflecting elements 2 and 3 do not intersect the flows forwarded by reflecting elements 2, 3 and 4, because their time periods of flight along the said directions are different and do not concur.

The method and its characterizing features were verified by a pilot crusher using active impact.

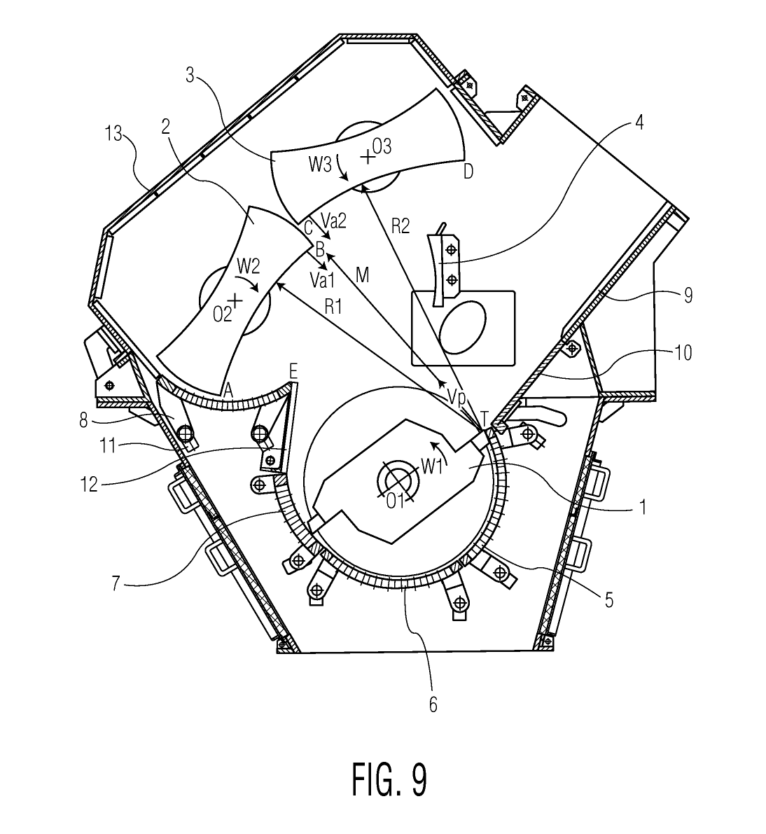

FIG. 9 shows the active impact crusher comprising the aforementioned construction innovations. The impact crusher includes a body 13 housing the reflecting elements (or rotors) 2 and 3, the actuator (or forwarding rotor) 1, the feed track 10, the supplying track 9, the limiters 5, 6, 7, 8, relocating devices in the grooves 11, the buffer 12 and the additional reflecting element (or reflector) 4.

In the active impact crusher, which body 13 encloses three kinematically connected synchronously rotatable rotors including one forwarding rotor being the actuator 1 and two reflecting rotors being the first (lower) reflecting element 2 and the second (upper) reflecting element 3, the feeding hole and the supplying track 9 and the limiters 5, 6 placed under the rotor. The first reflecting element is rotatable in such a way that it is able to impact forwarded towards it the material pieces at the distance R₁ from the point T of loss the contact of the material to be crushed from the feed track and the impact surface of the actuator at the moment of its contact with the material. The second reflecting element is rotatable in such a way that it is able to impact forwarded towards it the material pieces at the distance R₂ from the point T of loss the contact of the material to be crushed with the feed track and the impact surface of the actuator at the moment of its contact with the material.

The reflecting elements are rotatable in such a way that the angle between the impact surface of each reflecting element interacting with the corresponding material pieces and the movement direction of these material pieces during the impacting the material pieces is 76 to 104 degrees (substantially perpendicular). Such a perpendicularity is provided by concentric shape of the impacting surfaces and their concentrically arrangement during the impacting the material pieces relative to the point of the collision of the actuator and the material to be crushed and by the fact, that the reflecting elements are rotatable in such a way that a value of a time interval between the impacts made by the impact surfaces of the first and second reflecting elements to the material pieces forwarded towards them is defined with use of the expression Δt=(0.7 . . . 1.3)(R₁/V₁−R₂/V₂), where V₁ is an average velocity of the material pieces forwarded towards the first reflecting element and V₂ is an average velocity of the material pieces forwarded towards the second reflecting element.

In a preferable embodiment of the crusher the value of the said time interval is defined with use of the expression Δt=R₁/V₁−R₂/V₂.

The additional reflecting element 4 having concave surface and throwing the material into the zone A-E of the first reflective element 2 rotation is placed on the line connecting the point T and the center O₃ of rotation of the second reflecting element 3 and is relocatable relative to the velocity vector of the crushed material reflected by the impact surface of the element 3 within the limits of 20° to each direction relative to its middle position. There are the limiters 5,6,7,8 under the actuator 1 and the element 2, they are moveable in grooves 11 of the crusher body by means of corresponding devices and form the adjustable gaps between the ends of the impact elements and the surfaces of the limiters and also form and adjust sizes of the effective cross-sections in the devices right up to their total closing. In order to produce the pieces of the material to be crushed of the prescribed size the feed track 10 is adjustable with respect to the point T of loss the contact with the material to be crushed, wherein the pivoted hinge is disposed at its upper part and the feed track can be fixed at the lower part continuously or discretely up to 15 degrees to each direction from its middle position. The bumper 12 attached to the limiters 7 and 8 is located between them and forms an expanding conical space between the actuator and the bumper.

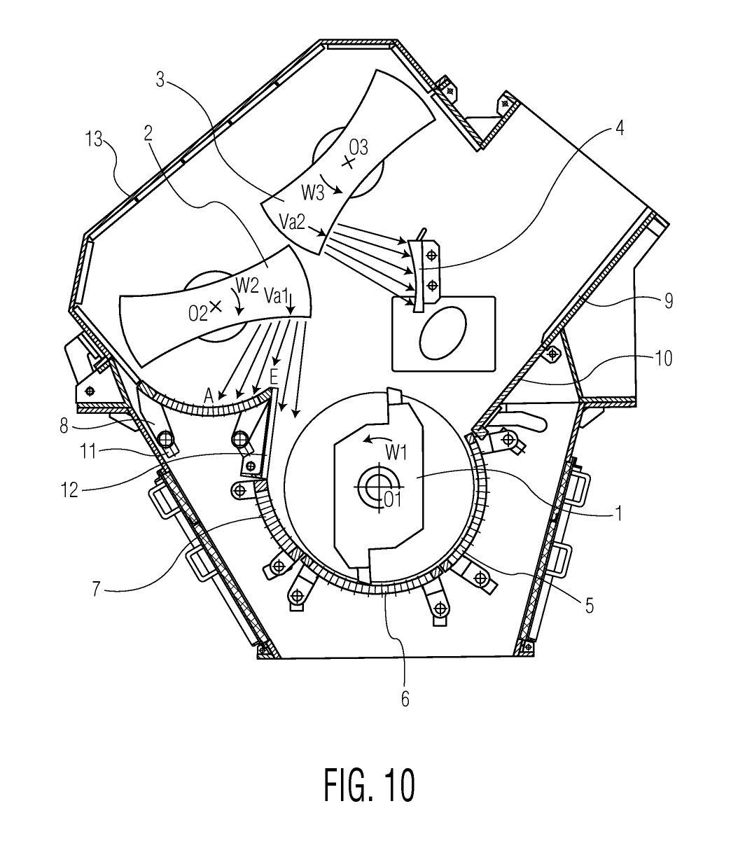

Crushing of mineral schematically shown by FIGS. 9 and 10 occurs as the following. The material to be crushed comes to the crushing chamber through a loading tray along the supplying track 9 and further along the feed track 10 set at necessary angle to one of the impact elements of the actuator 1 rotating at the angular velocity W₁, having the linear velocity Vₚ of the most distant from rotational axis point of the impact point and imparting the linear velocity V₁ and V₂ to the material thrown away towards the elements 2 and 3 (see FIG. 9). Deviations of the piece flight directions of the material to be crushed and thrown by the actuator off correspond to the Gaussian law determining that the pieces of small size are thrown off closer to the actuator towards the first reflecting element and the larger pieces are thrown off away from the actuator towards the second reflecting element. The velocity of the large pieces especially destroyed to small extent or not destroyed exceeds the circumferential velocity of the actuator rotor; this fact does not contrary to the classical theory of the impact. Dividing the flow of the thrown material on the line of the most probable partition of the large and small pieces corresponding to the mode M, the interaction of the material and the reflecting elements occurs at the distances R₁ and R₂. This interaction can occur simultaneously, if R₂=R₁(V₂/V₁).

At the moment of the interaction of the material to be crushed and the impact surfaces of the elements 2 and 3 the surface of the element 2 along the arc AB and the surface of the element 3 along the arc CD are disposed concentrically relative to the point T, where the actuator carries out the primary impact at the pieces of the material to be crushed; hence the large pieces will be crushed the most efficiently. The pieces of the material crushed by the element 3 are thrown off at the velocity Vₐ₂ to the additional reflecting element 4 and the crushed by the element 2 material is thrown off at the velocity Vₐ₁ to the limiters 6 and 7 and the limiter 8 and their openings are used for unloading and withdrawal of the crushed product. The material is reflected by the element 4 towards the limiter 8, where the material is intensively unloaded under the action of the element 2 (see FIG. 10). The buffer 12 can have openings in accordance with the requirements for the final product of the crushing.

The results shown at the table were obtained throughout the experiments.

It is remarkable that fine grinding was achieved at very low specific power consumption, when the limiters contained the large openings.

TABLE

| | | | | | Size of | Specific |
|---|---|---|---|---|---|---|
| | Size of raw | | Average size | | openings in | power |
| Material to | material, mm | | of crushed | Reduction | the limiters, | consumption, |
| be crushed | Max. | Avg. | product, mm | ratio | mm | kWh per |
| Granite | 350 | 250 | 2.0 | 125 | 30 | 0.20 |
| Quartzite | 70 | 40 | 0.56 | 71 | 10 | 0.18 |
| Dolomite | 150 | 95 | 2.1 | 45 | 12 | 0.09 |
| Complex | 300 | 180 | 2.2 | 90 | 20 | 0.06 |
| (polymetallic) | | | | | | |

Significantly increased crushing efficiency and quality of the final product and the main feature of the very low power consumption per ton of the grinded material, which is less three and more times than crushing methods in operation, reliably demonstrate that the proposed method provides new parameters and features for the ore pretreatment process and non-metallic mineral as well.

There has also appeared a possibility to control the fineness of the crushed material through setting of the necessary operational parameters as well.

1. A method of an impact crushing of material with use of a crusher comprising a feed track, an actuator with one or more impact surfaces and two reflecting elements with impact surfaces, wherein the actuator and the reflecting elements are rotatable synchronously, the method includes the following steps;
the material is fed with use of the feed track to the actuator;
the material is destructed by the actuator to pieces of different sizes and is forwarded towards the reflecting elements;
the material pieces forwarded towards the reflecting elements are contrary impacted by the impact surfaces of the reflecting elements, wherein the material pieces forwarded towards the first reflecting element are impacted by the impact surface of the first reflecting element and the material pieces forwarded towards the second reflecting element are impacted by the impact surface of the second reflecting element,
characterized in that
an angle between the impact surface of the each reflecting element interacting with the material pieces forwarded towards it and movement directions of these material pieces has a value from approximately 76 to approximately 104 degrees at the moment of the impact,
wherein the material pieces are impacted by the reflecting elements with a time interval between impacts of the first and second reflecting elements defined with use of the expression
Δt=(0.7 . . . 1.3)(R₁/V₁−R₂/V₂),
where R₁ is a distance from a place, where the most distant from the actuator rotation axis point of the impact surface of the actuator is at the minimum distance from the end of the feed track, to the place, where the first reflecting element impacts the material pieces,
R₂ is a distance from the place, where the most distant from the actuator rotation axis point of the impact surface of the actuator is at the minimum distance from the end of the feed track, to the place, where the second reflecting element impacts the material pieces,
V₁ is an average velocity of the material pieces forwarded towards the first reflecting element, and
V₂ is an average velocity of the material pieces forwarded towards the second reflecting element.

2. The method of claim 1, wherein the impacting surfaces of the reflecting elements have concentric shapes and concentric arrangement during the impacting the material pieces relative to the most distant from the actuator rotation axis point of the impact surface of the actuator.

3. The method of claim 1, wherein material pieces interacted with the second reflecting element are forwarded to a zone located under the first reflecting element with use of an additional reflecting element.

4. The method of claim 1, wherein the mode of crushing providing the relations
V₁=(0.1 . . . 0.35)(Vₚ+Vₐ₁),
V₂=(0.1 . . . 0.35)(Vₚ+Vₐ₂),
where Vₚ is the linear velocity of the most distant from the actuator rotation axis point of the impact surface of the actuator, Vₐ₁ and Vₐ₂ are the linear velocities of the most distant from corresponding reflecting element rotation axes points of the impact surfaces of the first and second reflecting elements, is set by adjustment of the velocities of the actuator and the reflecting elements, and the material interacted with the reflecting elements is forwarded to limiters set tangentially relative to the direction of the material pieces motion.

5. The method of claim 1, wherein the material crushed throughout the interaction with the reflecting elements and consisting of the particles less than 0.2 millimeters is withdrawn from the process by means of the suction devices.

6. An impact crusher comprising a body containing a feed track, an actuator with one or more impact surfaces and two reflecting elements with impact surfaces, wherein the actuator and the reflecting elements are rotatable synchronously, wherein the actuator is able to impact material fed by the feed track and forward material pieces towards the reflecting elements, wherein the reflecting elements are able to contrary impact the material pieces forwarded towards them by impact surfaces of the reflecting elements, characterized in that
the actuator and reflecting elements are rotatable in such a way that an angle between the impact surface of the each reflecting element interacting with the material pieces forwarded towards it and movement directions of these material pieces has a value from approximately 76 to approximately 104 degrees at the moment of the impact,
wherein the reflecting elements are rotatable in such a way that a value of a time interval between the impacts made by the impact surfaces of the first and second reflecting elements on the material pieces forwarded towards them is defined with use of the expression
Δt=(0.7 . . . 1.3)(R₁/V₁−R₂/V₂),
where R₁ is a distance from a place, where the most distant from the actuator rotation axis point of the impact surface of the actuator is at the minimum distance from the end of the feed track, to the place, where the first reflecting element impacts the material pieces,
R₂ is a distance from the place, where the most distant from the actuator rotation axis point of the impact surface of the actuator is at the minimum distance from the end of the feed track, to the place, where the second reflecting element impacts the material pieces,
V₁ is an average velocity of the material pieces forwarded towards the first reflecting element, and
V₂ is an average velocity of the material pieces forwarded towards the second reflecting element.

7. The crusher of claim 6, wherein the impacting surfaces of the reflecting elements have concentric shapes and are concentrically arranged during the impacting the material pieces relative to the most distant from the actuator rotation axis point of the impact surface of the actuator.

8. The crusher of claim 6, wherein an additional reflecting element is located between the actuator and the second reflecting element and is reflecting the material pieces forwarded by the second reflecting element to a zone under the first reflecting element.

9. The crusher of claim 8, wherein the additional reflecting element is located between the actuator and the second reflecting element in the vertex of the triangle having a base passing from the place, where the most distant from the actuator rotation axis point of the impact surface of the actuator is at the minimum distance from the end of the feed track, to a place, where the most distant from corresponding reflecting element axes points of the impact surfaces of the reflecting elements are at the minimum distance from each other, wherein the angle between the base of the triangle and a side of the triangle connecting the center of a reflecting surface of the additional reflecting element and the place, where the most distant from the actuator rotation axis point of the impact surface of the actuator is at the minimum distance from the end of the feed track, is about 35 degrees plus-minus 10 degrees.

10. The crusher of claim 9, wherein the additional reflecting element is adjustable at its angular position within the limits of 20 degrees to each direction relative to its middle angular position.

11. The crusher of claim 6, wherein limiters forming a gap between the actuator or the reflecting element and a surface of the limiter are placed in the crusher.

12. The crusher of claim 11, wherein the limiters comprise clearing openings.

13. The crusher of claim 11, wherein a bumper is located between the limiters of the actuator and the first reflecting element.

14. The crusher of claim 13, wherein the bumper comprises clearing openings.

15. The crusher of claim 6, wherein the feed track is adjustable on the position of the feed track end with respect to the actuator, wherein the feed track comprises a pivoted hinge at the upper part of the feed track and fixing means at the lower part of the feed track, wherein the fixing means are able to fix the feed track continuously or discretely up to 15 degrees to each direction from the middle position of the feed track.

16. The crasher of claim 6, wherein the distances R₁ and R₂ have the following relation: R₁≦R₂≦(V₂/V₁)R₁.

17. The crasher of claim 16, wherein the distance R₂=(V₂/V₁)R₁ and Δt=0.
